(19) United States
(12) Patent Application Publication
(10) Pub. No.: US 2026/0290972 A1
(43) Pub. Date: Sep. 24, 2026

(54) Battery Module

(71) Applicants: AISIN KEIKINZOKU CO., LTD., Imizu-shi (JP); TOYOTA JIDOSHA KABUSHIKI KAISHA, Toyota-shi (JP)

(72) Inventors: Tetsuya SANAE, Toyama-shi (JP); Takumi GONOJI, Toyama-shi (JP); Kota FUNAKI, Toyota-shi (JP); Takayuki SUGIYAMA, Toyota-shi (JP); Hajime KURIKUMA, Inuyama-shi (JP)

(21) Appl. No.: 19/565,796

(22) Filed: Mar. 13, 2026

(30) Foreign Application Priority Data
Mar. 18, 2025 (JP) 2025-043039

(51) Int. Cl. H01M 50/242; H01M 50/209

(52) U.S. Cl. CPC H01M 50/242; H01M 50/209

(57) ABSTRACT

A battery module comprises a stack formed by stacking a plurality of battery cells in a stacking direction, a pair of end plates that hold and sandwich the stack between the pair of the end plates in the stacking direction; and a connecting member that connects the pair of end plates. Each of the pair of end plates has a plurality of blind holes, each having a bottom on one of upper and lower directions.

### CROSS REFERENCE TO RELATED APPLICATIONS

This application is based upon and claims the benefit of priority to Japanese Patent Application No. 2025-043039 filed on March 18, 2025, the entire contents of which are incorporated herein by reference.

### BACKGROUND OF THE INVENTION

The present disclosure relates to a battery module, particularly to the structure of a pair of end plates.

Conventionally, battery modules comprising multiple stacked battery cells have been used.

For example, JP Patent No. 3426445 and JP Patent No. 6568900 disclose battery modules where a pair of end plates, made of extruded metal material, clamp and restrain multiple battery cells in the stacking direction. Each end plate has multiple through holes in the vertical direction.

JP Patent No. 3426445 discloses that through holes for fixing the battery module and through holes for fixing external connection terminals to the end plates are provided in the end plates (paragraph 0043).

JP Patent No. 6568900 discloses that through holes for engaging hooks of a battery suspension fixture are provided in the end plate (FIGS. 13 to 15).

However, while holes penetrating vertically may be effective for weight reduction, they do not sufficiently address overall space savings when mounting the battery module in vehicles, etc., or strength and vibration resistance when the battery cells are subjected to stacking directional loads.

### BRIEF DESCRIPTION OF THE DRAWINGS

FIG. 1 shows an example structure of a battery module according to the present disclosure.

FIG. 2 shows an isometric view of the end plate.

FIG. 3 shows a plan view of the end plate.

FIG. 4 shows a sectional view along line A-A in FIG. 3.

FIG. 5 shows a cross-sectional view along line B-B in FIG. 3.

FIG. 6 shows another embodiment of the end plate.

### DETAILED DESCRIPTION

The following disclosure provides many different embodiments, or examples, for implementing different features of the subject matter provided. These are, of course, merely examples and are not intended to be limiting. In addition, the disclosure may repeat reference numerals and/or letters in the various examples. This repetition is for the purpose of simplicity and clarity and does not in itself dictate a relationship between the various embodiments and/or configurations discussed. Furthermore, when a first element is described as "connected" or "coupled" to a second element, such description includes embodiments in which the first and second elements are directly connected or coupled to each other, and also includes embodiments in which the first and second elements are indirectly connected or coupled to each other with one or more other intervening elements in between.

An object of some aspects of the disclosure is to provide a battery module equipped with an end plate that offers lightweight construction along with high strength, vibration resistance, and other excellent properties.

An object of some other aspects of the disclosure is to provide a battery module that excels in saving space.

In accordance with one of some aspects, there is provided a battery module comprising: a stack formed by stacking a plurality of battery cells in a stacking direction; a pair of end plates that hold and sandwich the stack between the pair of the end plates in the stacking direction; and a connecting member that connects the pair of end plates, wherein each of the pair of end plates has a plurality of blind holes, each having a bottom on one of upper and lower directions.

By incorporating the blind holes into the end plate, the weight of the end plate is reduced. Placing the bottom of the blind hole on the side requiring strength compensates for the end plate 's lack of strength, making it easier to maintain the overall strength balance of the entire battery module.

For example, having the bottoms of the blind holes on the lower side lowers the center of gravity of the end plates, making the battery module more resistant to vibrations in vehicles where the battery module is installed, while also improving the bending rigidity of the end plates in the stacking direction despite their light weight.

In the present disclosure, it is preferable that each of the pair of end plates further comprises through holes penetrating in the upper and lower directions.

This allows fasteners such as bolts to be inserted through the through holes to secure the battery module to vehicles or other structures. Compared to fastening structures where brackets are fixed to the outer surface of the end plate in the stacking direction, the battery module of the present disclosure offers superior space savings and weight reduction.

The blind hole may have a tapered opening end that is larger in diameter than the bottom.

An end plate with such a blind hole can be easily manufactured by die casting, and it is preferable that each of the pair of end plates is made of die-cast material.

For example, forming them using a mold with the same ejection direction allows the extension directions of the blind holes and through holes to be easily made the same, enabling low-cost manufacturing.

The battery module according to the present disclosure ensures the protective strength of the battery module and enables weight reduction by providing blind holes in each of the pair of end plates.

Furthermore, cooling of the battery module is possible by flowing a coolant, etc., through the blind holes.

Exemplary embodiments are described below. Note that the following exemplary embodiments do not in any way limit the scope of the content defined by the claims laid out herein. Note also that all of the elements described in the present embodiment should not necessarily be taken as essential elements.

An embodiment of the battery module according to the present disclosure is described below with reference to the accompanying drawings, but is not limited thereto.

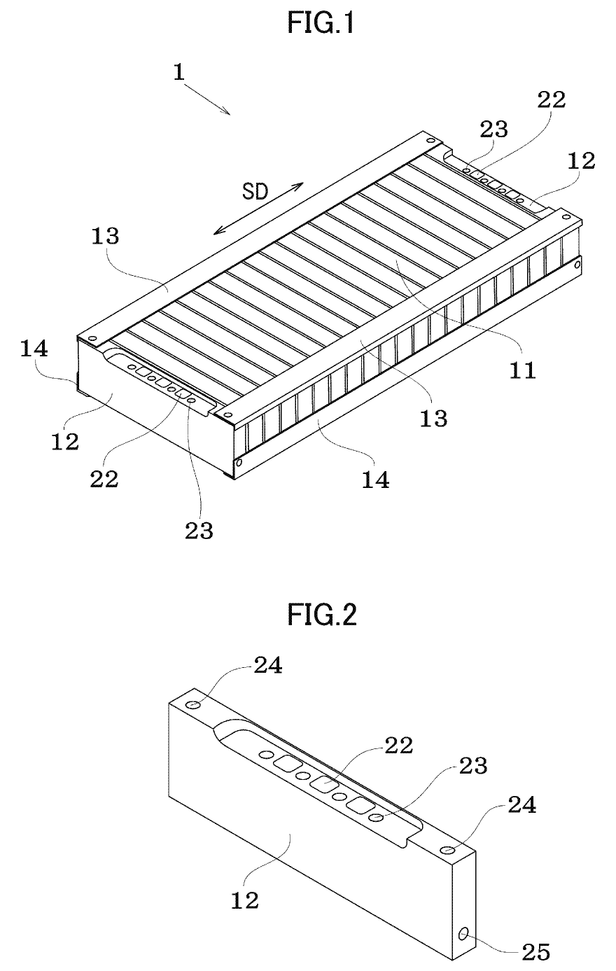

FIG. 1 shows an example structure of a battery module 1.

The battery module 1 comprises a stack 11 formed by stacking a plurality of battery cells in a stacking direction SD, a pair of end plates 12, 12 that hold and sandwich the stack 11 between the pair of the end plates 12, 12 in the stacking direction SD, and connecting members 13, 14 that connect the pair of end plates 12, 12.

In this embodiment, end plates 12, 12 are disposed on both end faces of the stack 11, which is formed by stacking a plurality of battery cells having a cubic shape, and the connecting members 13, 14 fix the stack 11 in a state where the plurality of battery cells are pressed in the stacking direction SD.

The connecting members 13, 14, for example, arranged at the four corners of the stack 11 and extending in the stacking direction SD, are exemplified as comprising two first connecting members 13 and two second connecting members 14, each having an L-shaped cross-section. For example, a pair of iron first connecting members 13 are fixed to the upper side of the pair of end plates 12, 12, and a pair of iron second connecting members 14 are fixed to the lower side of the pair of end plates 12, 12.

There are no particular restrictions on the structure or number of connecting members 13, 14. For example, the first and second connecting members 13, 14 may be integrally formed.

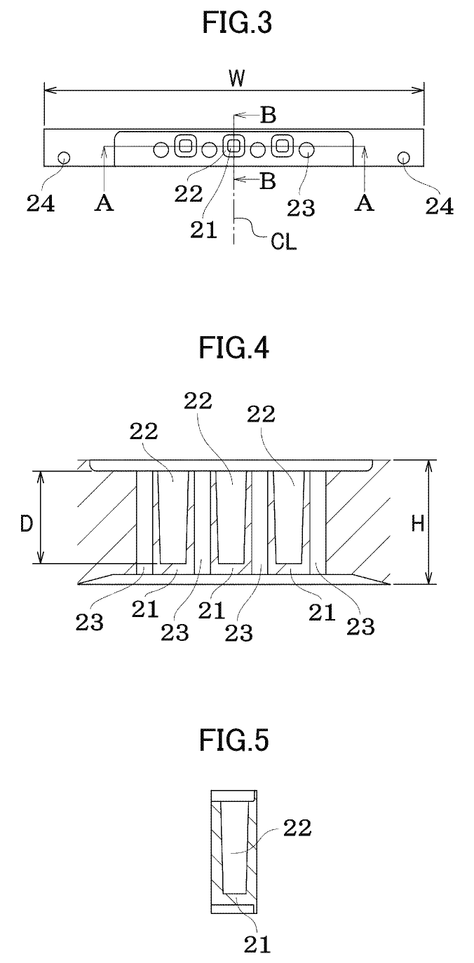

Regarding an example structure of the end plate 12, FIG. 2 shows an isometric view, FIG. 3 shows a plan view, FIG. 4 shows a cross-sectional view along line A-A, and FIG. 5 shows a cross-sectional view along line B-B.

The end plate 12 is provided with a plurality of blind holes or bottomed holes 22, each having a bottom 21 on one of upper and lower directions (vertical directions).

As shown in FIG. 4, when the bottom 21 of the blind hole 22 is located on the lower side, positioning the bottom 21 below the midpoint in the vertical directions facilitates larger material removal for weight reduction. Specifically, the depth D of the blind hole 22 is preferably H/2 or greater, where H is the height of the end plate 12.

Positioning the bottom 21 on the lower side of the blind hole 22 allows the center of gravity of the end plate 12 to be lowered. However, the bottom 21 may also be positioned on the upper side of the blind hole 22. Placing the bottom 21 on the side requiring strength compensates for the end plate 12's lack of strength, making it easier to maintain the overall strength balance of the entire battery module 1.

As disclosed herein, the ability to adjust the strength-securing portion by providing blind holes in the end plate 12 allows, for example, the end plate 12, which is formed as a substantially plate-shaped member with parallel outer and inner surfaces in the stacking direction SD as in this embodiment, readily receives loads in the stacking direction SD of the battery cell on its flat surface. This prevents the length of the battery module 1 in the stacking direction SD from becoming bulky, facilitating space-saving when mounted in vehicles, etc.

Furthermore, the blind holes 22 extending in the upper and lower directions may allow refrigerant or similar fluids to pass through their reduced-material sections. This facilitates cooling the interior of the end plate 12, thereby improving component quality.

Such blind holes 22 can also be utilized as space for mounting other components or as storage space for other components.

In addition to the blind holes 22, the end plate 12 may further have through holes 23 extending in the upper and lower directions.

A fastener such as a bolt can be inserted through the through hole 23 to mount the battery module 1 to the vehicle floor or a case body that houses the battery module.

By fastening the battery module 1 via the through hole 23 in this manner, separate mounting brackets or the like are unnecessary, resulting in improved space efficiency.

In the present disclosure, as shown in the plan view of FIG. 3, it is preferable that a plurality of blind holes 22 and a plurality of through holes 23 are symmetrically arranged with respect to each center line CL that bisects the width W of each of the pair of end plates 12, 12 in a direction orthogonal to the stacking direction SD.

The line-symmetrical arrangement of the plurality of blind holes and the plurality of through holes maintains the overall strength balance of the battery module 1.

Furthermore, considering that the through holes 23 are used to stably secure the battery module 1, it is preferable to position the two through holes 23 at the outermost positions of the line-symmetrical arrangement.

This embodiment provides three blind holes 22 and four through holes 23, but there is no limitation on the number of blind holes 22 or through holes 23.

Furthermore, while this example shows the blind holes 22 and through holes 23 arranged alternately in the left-right direction when viewed in plan, this is not limiting.

Such an end plate 12 may be made of a metal die-cast material, such as aluminum or an aluminum alloy, obtained by die-casting.

By making the extension directions of the blind holes 22 and the through holes 23 the same, molding is possible using a mold with the same ejection direction, enabling inexpensive manufacturing.

The blind holes 22 in this embodiment are tapered, with the opening end (the upper end in FIG. 4) of the blind hole 22 having a larger diameter than the bottom 21, allowing for easy die-cutting due to the draft angle.

When forming with a mold, the blind hole and through hole may be formed using a slide core.

This facilitates free shape design of, for example, the side portions of the end plate using movable and fixed dies, and allows easy forming of assembly holes for other parts or mating structures into the end plate.

In this embodiment, as shown in FIG. 2, fixing holes 24 and 25 are provided in the end plate 12. Fixing hole 24 is a hole for fixing the first connecting member 13 with a bolt, etc. Fixing hole 25 is a hole for fixing the second connecting member 14 with a bolt, etc. In this embodiment, fixing hole 24 is provided on the upper surface of the end plate 12, but it may also be provided on the side surface. In this embodiment, fixing hole 25 is provided on the side surface of end plate 12, but it may also be provided on the bottom surface. However, as long as the stack 11 can be constrained between the pair of end plates 12, 12, there are no restrictions on the position of the fixing means or fixing holes.

Here, in the plan view shown in FIG. 3, it is preferable that the plurality of blind holes 22 and the plurality of through holes 23 are positioned offset toward the respective center lines CL from the widthwise ends of the pair of end plates 12, 12. This prevents interference with the fixing holes 24 that may be formed on the upper surface of the pair of end plates 12, 12.

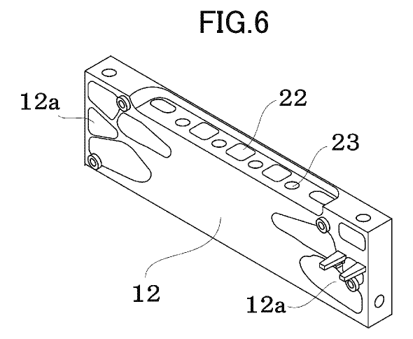

FIG. 6 shows another example of the end plate 12.

This embodiment features a cast recess 12a formed by casting from the side onto the outer surface of the end plate 12 in the stacking direction SD. Placing the cast recess 12a on the side of the end plate 12 allows for greater weight reduction without affecting the blind holes 22 or through holes 23 located at the width-direction center.

Although only some embodiments of the present invention have been described in detail above, those skilled in the art will readily appreciate that many modifications are possible in the embodiments without materially departing from the novel teachings and advantages of this invention. Accordingly, all such modifications are intended to be included within the scope of this invention.

1. A battery module comprising: a stack formed by stacking a plurality of battery cells in a stacking direction; a pair of end plates that hold and sandwich the stack between the pair of the end plates in the stacking direction; and a connecting member that connects the pair of end plates, wherein each of the pair of end plates has a plurality of blind holes, each having a bottom on one of upper and lower directions.

2. The battery module according to claim 1, wherein a depth of each of the plurality of blind holes is at least one-half of a length of each of the pair of end plates in the upper and lower directions.

3. The battery module according to claim 1, wherein each of the pair of end plates further has a plurality of through holes penetrating in the upper and lower directions.

4. The battery module according to claim 3, wherein, in a plan view, the plurality of blind holes and the plurality of through holes are arranged in line symmetry with respect to each centerline bisecting a width of each end plate in a width direction perpendicular to the stacking direction.

5. The battery module according to claim 4, wherein two of the plurality of through holes are provided at the outermost positions of a line-symmetrical arrangement of the plurality of blind holes and the plurality of through holes.

6. The battery module according to claim 4, wherein, in plan view, the plurality of blind holes and the plurality of through holes are disposed offset toward the respective center lines from respective widthwise ends of the pair of end plates.

7. The battery module according to claim 1, wherein each of the plurality of blind holes is a tapered hole, wherein the opening end is enlarged relative to the bottom.

8. The battery module according to claim 7, wherein each of the pair of end plates is made of die-cast material.

9. The battery module according to claim 6, wherein each of the pair of end plates is made of die-cast material, and
wherein each of the pair of end plates has a cast recess on an outer surface in the stacking direction at the respective widthwise ends of the pair of end plates.
